(19) United States
(12) Patent Application Publication
(10) Pub. No.: US 2025/0338231 A1
(43) Pub. Date: Oct. 30, 2025

(54) SYSTEMS AND METHODS FOR ADAPTIVE AVERAGE POWER TRACKING

(71) Applicant: HFCL Limited, Bangalore (IN)

(72) Inventors: Parag Aggarwal, Bangalore (IN); Subhas Chandra Mondal, Bangalore (IN)

(21) Appl. No.: 19/192,406

(22) Filed: Apr. 29, 2025

(30) Foreign Application Priority Data
Apr. 29, 2024 (IN) 202441033935

(51) Int. Cl. H04W 52/42; H04W 52/22; H04W 52/32

(52) U.S. Cl. CPC H04W 52/42; H04W 52/225; H04W 52/325

(57) ABSTRACT

Systems (200) and methods (300) for adaptive average power tracking are described. In particular, the method includes determining an average power of each of a plurality of Orthogonal Frequency-Division Multiplexing (OFDM) symbols in a radio frame based on a set of power scaling factors and a number of Resource Elements (REs) associated with each OFDM symbol, comparing the average power of each of the plurality of OFDM symbols with a power threshold value, detecting one or more faulty OFDM symbols among the plurality of OFDM symbols based on the comparison, modifying the one or more faulty OFDM symbols, determining an average power of a set of OFDM symbols, including the one or more modified OFDM symbols, corresponding to an averaging window, and generating a modulated voltage supply for a power amplifier in the wireless communication system based on the determined average power of the set of OFDM symbols.

### CROSS REFERENCE TO RELATED APPLICATIONS

The present application claims the benefit of Indian Patent Application No. 202441033935 filed on Apr. 29, 2024, the contents of which are incorporated herein by reference in their entirety.

### TECHNICAL FIELD

The present disclosure, in general, relates to managing power in a wireless communication device in a network, and in particular, relates to systems and methods for adaptive average power tracking with power amplifier protection in a wireless communication system, for example, 5G system.

### BACKGROUND

The fifth-generation (5G) macro base station (BS) with multiple antennas has a huge coverage area. It uses a high-power amplifier (HPA) for each antenna to boost the signal so that it can reach the edges of the coverage area. It requires a large amount of transmit power and results in a huge amount of energy consumption. Operating the HPA in the saturation region increases the overall energy efficiency of the BS. However, in 5G BS, the envelope of the transmit signal varies significantly over time, which prevents operating the HPA in the saturated state. This means a loss of efficiency since HPAs are most efficient when operated at their peak output power. The HPA is forced to operate way below its peak output power at low instantaneous powers. As a result, a significant amount of power is dissipated as heat. Similar scenario occurs in other 5G devices like user equipment (UE), smartphones, customer premises equipment (CPE), and the like.

To overcome the above problem, average power tracking (APT) is applied in conventional systems. The idea of APT is to dynamically adjust the supply voltage of the PA according to the average power of Radio Frequency (RF) input signal over a given period of time. By modulating the supply voltage, the HPA's efficiency is significantly increased. This yields a low power budget of 5G devices.

A conventional architecture of a system (100) is shown in FIG. 1. A System on Chip (SoC) contains a processing system and programming logic for baseband processing of the incoming data and other control functions. A higher layer (104) consists of Medium Access Control (MAC) and Radio Link Control (RLC) layers. A Physical (PHY) layer (106) processes the incoming bits from the higher layers into the time domain in-phase quadrature (IQ) symbols. Digital front end (DFE) (108) processes the time domain IQ symbols with crest factor reduction (CFR), digital predistortion (DPD), and digital upconverter (DUC). Digital to Analog converter (DAC) (110) converts the digital signal into an analog signal. HPA (112) is an amplifier that amplifies the signal with the desired output power before transmission. An Average Power Detector (APD) (114-1) calculates the average power of the time-domain IQ symbols over a given period of time. Look-up table (LUT) (116) provides a modulated voltage supply (V_{dd}) value based on the calculated average power. A Delay unit (118) delays the modulated voltage supply value so that RF input signal at PA output and modulated voltage supply are aligned in time. A supply modulator (120) generates the modulated voltage supply for the HPA (112) accordingly.

Generally, APD (114-1) calculates the average power of the signal over the fixed duration of time which may be one or more slot durations. 4G/Long Term Evolution (LTE) has single numerology which means that all the slots in one radio frame have same duration. Thus, it may be easy to maintain the periodicity of APT. However, the same is not true for 5G due to the flexible structure of 5G radio frame.

Modern applications such as autonomous vehicles, Internet of Things (IoT), and high-speed video streaming have different demands which may not be fulfilled by the rigid frame structure. Thus, the 5G frame structure has been designed to adapt itself according to the requirements of each application, making the entire network more efficient. The 5G frame structure is based on a slot and symbol-based design. With the mixed numerologies, the duration of slot and symbols are different, as given in Table A below. Furthermore, the mini-slots allow the 5G frame structure to provide faster response times for certain applications.

TABLE A

| | Δf | | Tₛₗₒₜ | T_{symbol}^{Normal} |
|---|---|---|---|---|
| μ | (kHz) | Nₛₗₒₜ^{frame, μ} | (us) | (us) |
| 0 | 15 | 10 | 1000 | 71.35 |
| 1 | 30 | 20 | 500 | 35.68 |
| 2 | 60 | 40 | 250 | 17.84 |
| 3 | 120 | 80 | 125 | 8.92 |
| 4 | 240 | 160 | 62.5 | 4.46 |
| 5 | 480 | 320 | 31.25 | 2.23 |
| 6 | 960 | 640 | 15.625 | 1.12 |

where
μ is the subcarrier spacing configuration.
Δf is the subcarrier spacing.
Nₛₗₒₜ^{frame, μ} is the number of slots per frame for μ.
Tₛₗₒₜ is the slot duration.
T_{symbol}^{Normal} is the symbol duration with normal CP.

Periodic APT (i.e., fixed averaging window) may not be an optimal solution for the 5G network, because it may not dynamically adjust the duration of each slot/symbol.

Therefore, there is a need for a system and a method for adaptive average power tracking in a wireless communication system.

### OBJECTS OF THE PRESENT DISCLOSURE

It is an object of the present disclosure to provide a system and a method for adaptive average power tracking in a wireless communication system.

It is an object of the present disclosure to prevent power amplifier and other components in the wireless communication system from damage.

It is an object of the present disclosure to utilize information from a higher layer to optimize hardware resource utilization.

### SUMMARY

In an aspect, the present disclosure relates to a method for adaptive average power tracking in a wireless communication system, including determining, by a processor, an average power of each of a plurality of Orthogonal Frequency-Division Multiplexing (OFDM) symbols in a radio frame based on a set of power scaling factors and a number of Resource Elements (REs) associated with each OFDM symbol, comparing, by the processor, the average power of each of the plurality of OFDM symbols with a power threshold value, detecting, by the processor, one or more faulty OFDM symbols among the plurality of OFDM symbols based on the comparison, modifying, by the processor, the one or more faulty OFDM symbols, determining, by the processor, an average power of a set of OFDM symbols, including the one or more modified OFDM symbols, corresponding to an averaging window, and generating, by the processor, a modulated voltage supply for a power amplifier in the wireless communication system based on the determined average power of the set of OFDM symbols.

In an embodiment, determining, by the processor, the average power of each of the plurality of OFDM symbols may include receiving, by the processor, the set of power scaling factors of physical channels and reference signals from a higher layer in the wireless communication system, determining, by the processor, power scaling factors of multiple-input multiple-output (MIMO) precoding weights and/or beamforming weights for each transmit chain associated with the wireless communication system, and determining, by the processor, the number of REs associated with the physical channels and the reference signals mapped to each OFDM symbol.

In an embodiment, the average power of each of the plurality of OFDM symbols may be determined based on at least one of: the set of power scaling factors of the physical channels and the reference signals, the power scaling factors of the MIMO precoding weights and/or the beamforming weights, and the number of REs associated with the physical channels and the reference signals.

In an embodiment, detecting, by the processor, the one or more faulty OFDM symbols may include, for each of the plurality of OFDM symbols, determining, by the processor, whether the average power of a given OFDM symbol is less than the power threshold value, in response to a determination that the average power of the given OFDM symbol is less than the power threshold value, identifying, by the processor, that the given OFDM symbol is not faulty, and in response to a determination that the average power of the given OFDM symbol is greater than the power threshold value, identifying, by the processor, that the given OFDM symbol is a faulty OFDM symbol.

In an embodiment, modifying, by the processor, the one or more faulty OFDM symbols may include, for each of the one or more faulty OFDM symbols, initiating, by the processor, a timer for a predetermined time period, and a counter to zero, transmitting, by the processor, an error flag corresponding to a given faulty OFDM symbol to a higher layer in the wireless communication system, and determining, by the processor, whether the higher layer responds with updated parameters corresponding to the given faulty OFDM symbol within the predetermined time period.

In an embodiment, the method may include in response to a determination that the higher layer does not respond within the predetermined time period, configuring, by the processor, zeroes in REs of the given faulty OFDM symbol, or in response to a determination that the higher layer responds within the predetermined time period, determining, by the processor, an updated average power of the given faulty OFDM symbol, based on the updated parameters received from the higher layer, determining, by the processor, whether the updated average power is less than the power threshold value, and in response to a determination that the updated average power is greater than the power threshold value, increasing, by the processor, a count of the counter and determining, by the processor, whether the count is less than a counter threshold value.

In an embodiment, the method may include in response to a determination that the count is less than the counter threshold value, re-transmitting, by the processor, the error flag to the higher layer, or in response to a determination that the count is greater than the counter threshold value, configuring, by the processor, the zeroes in the REs of the given faulty OFDM symbol.

In an embodiment, the method may include determining, by the processor, whether the averaging window is periodic or adaptive.

In an embodiment, in case of the averaging window being periodic, the method may include determining, by the processor, a periodicity of the averaging window, and storing, by the processor, the average power of the set of OFDM symbols corresponding to the averaging window and an index of a start of the averaging window in a database.

In an embodiment, in case of the averaging window being adaptive, the method may include determining, by the processor, a structure of the radio frame, and storing, by the processor, the average power of the set of OFDM symbols corresponding to the averaging window and an index of a first OFDM symbol corresponding to one of: the set of OFDM symbols within a mini-slot, the set of OFDM symbols having same numerology, or the set of OFDM symbols where the average power of a number of consecutive OFDM symbols lies in same range of a Look-Up Table (LUT).

In an embodiment, generating, by the processor, the modulated power supply may include receiving, by the processor, a symbol indicator of a first OFDM symbol of the set of OFDM symbols from a timing module in the wireless communication system, converting, by the processor, the average power of the set of OFDM symbols into a codeword using a LUT at the symbol indicator of the first OFDM symbol, and generating, by the processor, the modulated power supply based on the codeword, wherein the modulated power supply may be delayed to align with an input signal at the power amplifier.

In an aspect, the present disclosure relates to a system for adaptive average power tracking, including a processor, and a memory operatively coupled with the processor, wherein the memory includes processor-executable instructions which, when executed by the processor, cause the processor to determine an average power of each of a plurality of OFDM symbols in a radio frame based on a set of power scaling factors and a number of REs associated with each OFDM symbol, compare the average power of each of the plurality of OFDM symbols with a power threshold value, detect one or more faulty OFDM symbols among the plurality of OFDM symbols based on the comparison, modify the one or more faulty OFDM symbols, determine an average power of a set of OFDM symbols, including the one or more modified OFDM symbols, corresponding to an averaging window, and generate a modulated voltage supply for a power amplifier in the system based on the determined average power of the set of OFDM symbols.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example architecture of a conventional system.

FIG. 2 illustrates an example representation of a proposed system, in accordance with an embodiment of the present disclosure.

FIG. 3 illustrates a high-level flow chart of an example method for adaptive average power tracking, in accordance with an embodiment of the present disclosure.

FIG. 4 illustrates a flow chart of an example method for symbol average power calculation, in accordance with an embodiment of the present disclosure.

FIG. 5 illustrates a flow chart of an example method for early power warning detection and mitigation, in accordance with an embodiment of the present disclosure.

FIG. 6 illustrates a flow chart of an example method for adaptive average power tracking, in accordance with embodiments of the present disclosure.

FIG. 7 illustrates an example representation of average power tracking with periodicity of two Orthogonal Frequency Division Multiplexing (OFDM) symbols, in accordance with an embodiment of the present disclosure.

FIG. 8 illustrates an example computer system in which or with which embodiments of the present disclosure may be implemented.

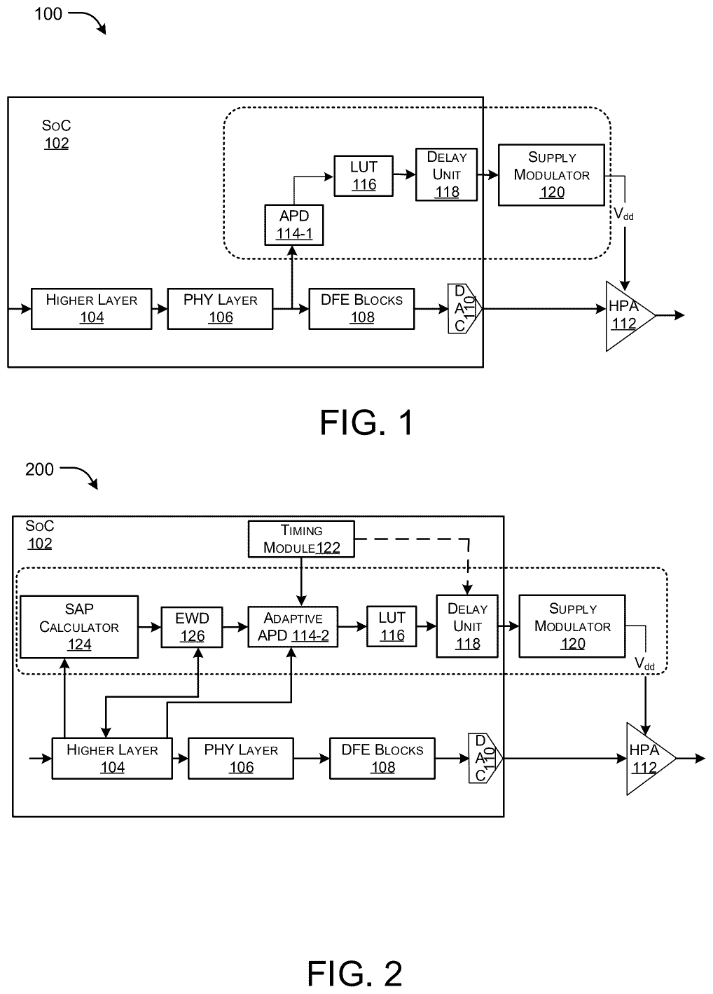

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

The various embodiments throughout the disclosure will be explained in more detail with reference to FIGS. 2-8.

FIG. 2 illustrates an example architecture of a system (200) for adaptive average power tracking, in accordance with an embodiment of the present disclosure.

In particular, the system (200) includes a System on Chip (SoC) (102), a higher layer (104), a Physical (PHY) layer (106), Digital Front End (DFE) blocks (108), Digital to Analog Converter (DAC) (110), and a Power Amplifier (PA) (112), for example, a High-PA (HPA) (112). Further, the system (200) includes a timing module (122), a Symbol Average Power (SAP) calculator (124), an Early Warning Detector (EWD) (126), an adaptive Average Power Detector (APD) (114-2), a Look-Up Table (LUT) (116), a delay unit (118), and a supply modulator (120).

Referring to FIG. 2, the timing module (122) may generate indicators for each symbol boundary (e.g., Orthogonal Frequency Division Multiplexing (OFDM) symbol), for each slot boundary, and for each frame boundary. The SAP calculator (124) may read parameters from the higher layer (104). The parameters may include, but not limited to, a set of power scaling factors of physical channels and reference signals related to a next frame. In some embodiments, the SAP calculator (124) may determine the power scaling factors introduced by multiple-input multiple-output (MIMO) precoding and/or beamforming weights for each transmit chain. The SAP calculator (124) may determine a number of Resource Elements (REs) associated with all the physical channels and the reference signals, which are mapped to different OFDM symbols. In some embodiments, the SAP calculator (124) may determine an average power of each of a plurality OFDM symbols in a radio frame based on the set of power scaling factors and the number of REs associated with each OFDM symbol.

The EWD (126) may check the average power of each OFDM symbol (P_{p,μ,l}) with a power threshold value (Pₜₕ) in order to detect data overflow in the DAC output (110). It may help in protecting the HPA (112) from damage. It may be appreciated that the power threshold value is configurable and can be defined as per design implementation. In some embodiments, the EWD (126) may detect one or more faulty OFDM symbols. In some embodiments, the EWD (126) may notify the higher layer (104) in case the average power of any OFDM symbol violates the power threshold value. In such a scenario, the EWD (126) may modify the faulty OFDM symbols with updated parameters (e.g., updated power scaling factors) if the higher layer (104) responds with the updated parameters. In some other embodiments, the EWD (126) may put zeros in the whole OFDM symbol to protect the HPA (112) as well as to maintain the data transmission continuity.

Referring to FIG. 2, the adaptive APD (114-2) may determine an average power of a set of OFDM symbols including the modified OFDM symbols corresponding to an averaging window. The adaptive APD (114-2) may determine whether the averaging window is periodic or adaptive. If the averaging window is periodic, the adaptive APD (114-2_ may determine periodicity of the averaging window, and based on the periodicity, the adaptive APD (114-2) may determine the number of OFDM symbols that arrive in that period. The adaptive APD (114-2) may read the average power of each OFDM symbol from the EWD (126) and measure their average power. In some embodiments, the adaptive APD (114-2) may wait for an indicator signal coming from the timing module (122) to release the average power to the LUT (116).

In some embodiments, the LUT (116) may provide a modulated voltage supply (V_{dd}) value based on the calculated average power of the set of OFDM symbols. The delay unit (118) may delay the modulated voltage supply value so that radio frequency (RF) input signal at the HPA output (112) and the modulated voltage supply are aligned in time. In some embodiments, the supply modulator (120) may generate the modulated voltage supply for the HPA (112) accordingly.

In some embodiments, the system (200) may be associated with a processor and a memory, such that the memory includes processor-executable instructions which, when executed by the processor, cause the processor to perform the methods described herein. It may be appreciated that the system (200) may correspond to a base station such as Next-Generation Node B (gNodeB), Evolved Node B (eNodeB), etc., a Customer Premises Equipment (CPE), user equipment, smartphone, or the like.

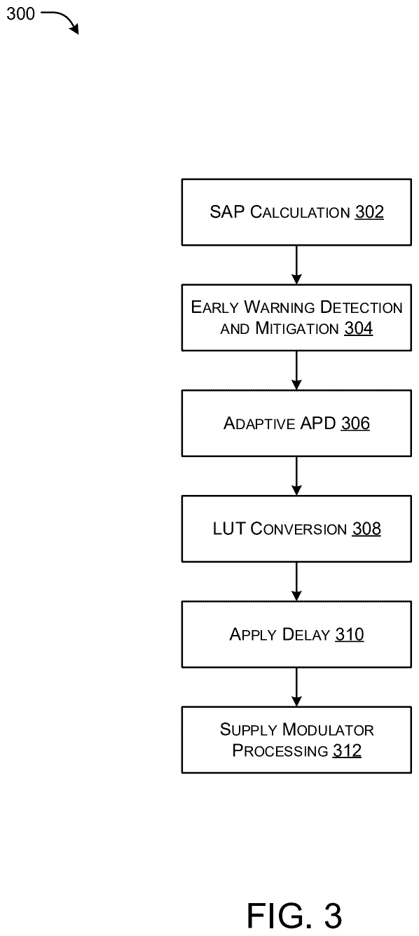

FIG. 3 illustrates a high-level flow chart of an example method (300) for adaptive average power tracking in a wireless communication system, in accordance with an embodiment of the present disclosure.

Referring to FIG. 3, at block 302, the method (300) includes SAP calculation by the SAP calculator (124). The method (300) may include calculating an average power of each OFDM symbol based on parameters from a higher layer (104). At block 304, the method (300) includes early warning detection and mitigation by the EWD (126). In some embodiments, the method (300) may include determining whether the calculated average power of each OFDM symbol violates a power threshold value or not. In some embodiments, the method (300) may include mitigating the early warning.

At block 306, the method (300) includes adaptive average power detection by the adaptive APD (114-2). The method (300) may include determining an averaging window and calculating the average power of the OFDM symbols mapped to the averaging window. At block 308, the method (300) includes LUT conversion by the LUT (116). Based on the average value received from the adaptive APD (114-2), a codeword may be selected from the LUT (116) for appropriate supply voltage. The LUT (116) depends on the HPA characteristics and may be generated as per the design implementation. The LUT (116) may be generated offline and saved in a local memory of the SoC (102).

Referring to FIG. 2, at block 310, the method (300) includes applying delay by the delay unit (118). The method (300) may include apply a delay value, which helps synchronize the modulated supply voltage and input signal to the HPA (112). In some embodiments, the value of delay may be provided by the timing module (122). In some other embodiments, I value of delay may be determined according to the design implementation. At block 312, the method (300) includes supply modulator processing by the supply modulator (120) such that on receiving the codeword, the supply modulator (120) may change the supply voltage of the HPA (112). The method (300) will be discussed in detail throughout the disclosure.

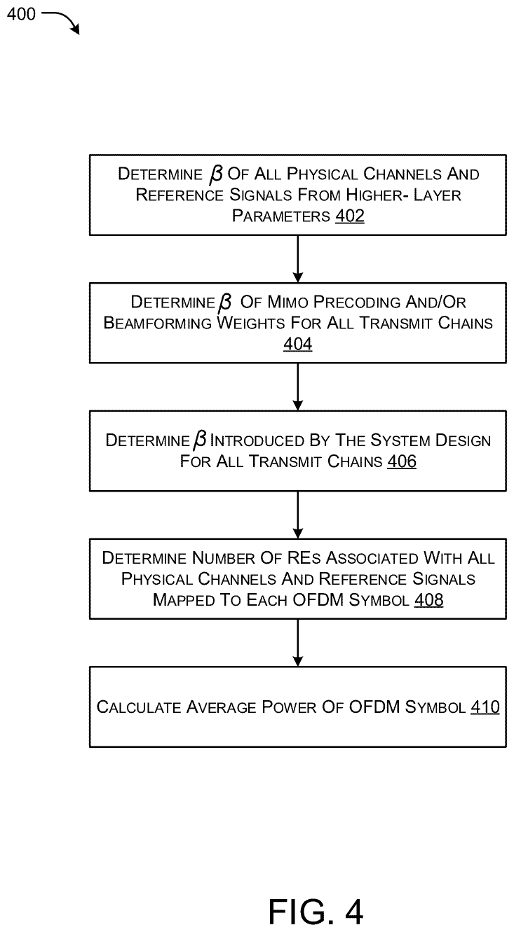

FIG. 4 illustrates a flow chart of an example method (400) for SAP calculation (302), in accordance with an embodiment of the present disclosure.

Referring to FIG. 4, at block 402, the method (400) includes determining a set of scaling factors (β) of all downlink physical channels and reference signals from the higher layer (104). For example, the physical channels and the reference signals used for downlink in the 5G new radio (NR) have different scaling factor as defined in the 3^{rd} Generation Partnership Project (3GPP) Technical Specification (TS) 38.211 and TS 38.214. The same is as shown in Table 1 below.

TABLE 1

| PHYSICAL CHANNEL OR REFERENCE | SCALING |
|---|---|
| SIGNAL | FACTOR |
| PHYSICAL BROADCAST CHANNE (PBCH) | β_{PBCH} |
| PHYSICAL DOWNLINK CONTROL CHANNEL | β_{PDCCH} |
| (PDCCH) | |
| PHYSICAL DOWNLINK SHARED CHANNEL | β_{PDSCH} |
| (PDSCH) | |
| PBCH-DEMODULATION REFERENCE SIGNAL | β_{PBCH}^{DMRS} |
| (DMRS) | |
| PDCCH-DMRS | β_{PDCCH}^{DMRS} |
| PDSCH-DMRS | β_{PDSCH}^{DMRS} |
| PHASE-TRACKING REFERENCE SIGNALS (PT- | β_{PT-RS} |
| RS) | |
| POSITIONING REFERENCE SIGNAL (PRS) | β_{PRS} |
| CHANNEL-STATE INFORMATION REFERENCE | β_{CSIRS} |
| SIGNAL (CSI-RS) | |
| PRIMARY SYNCHRONIZATION SIGNAL (PSS) | β_{PSS} |
| SECONDARY SYNCHRONIZATION SIGNAL | β_{SSS} |
| (SSS) | |

At block 404, the method (400) includes determining scaling factors of MIMO precoding and/or beamforming weights for all transmit chains. Generally, MIMO precoding and/or beamforming operations in the downlink maintain the total power of the system (200) in the spatial domain. However, there is a possibility that MIMO precoding and/or beamforming operations may change the average power of OFDM symbols which are allocated to different physical antenna ports. In the case of MIMO precoding (for both codebook and non-codebook), the method (400) may include determining the scaling factor β^{Precoding} for each OFDM symbol from the assigned precoding weights by the higher layer (104). In the case of beamforming (for both frequency and time domain), the method (400) may include determining the scaling factor β^{BF} for each OFDM symbol from the beamforming weights assigned by the higher layer (104).

At block 406, the method (400) includes determining the scaling factors introduced by system design for all the transmit chains. The design factors in the system (200) may impact the average power of the OFDM symbol. These factors may be additional weights for antenna calibration, the scaling factor of inverse Fast Fourier Transformation (iFFT) operation, and the like. These factors may be determined by the system parameters as per the design implementation. The scaling factor β^{Sys} can be used to represent the collective scaling factor introduced by the system (200).

Referring to FIG. 4, at block 408, the method (400) includes determining a number of REs associated with all the physical channels and the reference signals mapped to each OFDM symbol, for example, by determining the layer mapping and antenna port mapping from the higher layer (104). At block 410, the method (400) includes calculating the average power of each OFDM symbol. The average power of l^{th} OFDM symbol (P_{p,μ,l}) for physical antenna port p and subcarrier spacing configuration μ may be defined as:

$${P}_{p , μ , l} = \frac{{β}^{Precoding} {β}^{B F} {β}^{S y s}}{{N}_{f}} ( {β}_{P S S} {N}_{p , μ , l}^{P S S} + {β}_{S S S} {N}_{p , μ , l}^{S S S} + {β}_{P B C H} {N}_{p , μ , l}^{P B C H} + {β}_{P B C H}^{D M R S} {N}_{p , μ , l}^{P B C H - D M R S} + {β}_{P R S} {N}_{p , μ , l}^{P R S} + {β}_{R I M} {N}_{p , μ , l}^{R I M} + {β}_{C S I R S} {N}_{p , μ , l}^{C S I R S} + {β}_{P T - RS , i} {N}_{p , μ , l}^{PT - RS} + {β}_{P D C C H} {N}_{p , μ , l}^{PDCCH} + {β}_{P D C C H}^{D M R S} {N}_{p , μ , l}^{P DCCH - DMRS} + {β}_{P D S C H} {N}_{p , μ , l}^{P D S C H} + {β}_{P D S C H}^{D M R S} {N}_{p , μ , l}^{P D S C H - D M R S} )$$

### Where,

N_{f} is the FFT size. For example, it may be 4096 for 5G NR.

$${N}_{p , μ , l}^{x}$$

N is the number of REs carrying the physical channels or Demodulation Reference Signal (DMRS) of physical channels or reference signals with time-domain index l for physical antenna port p and subcarrier spacing configuration μ.

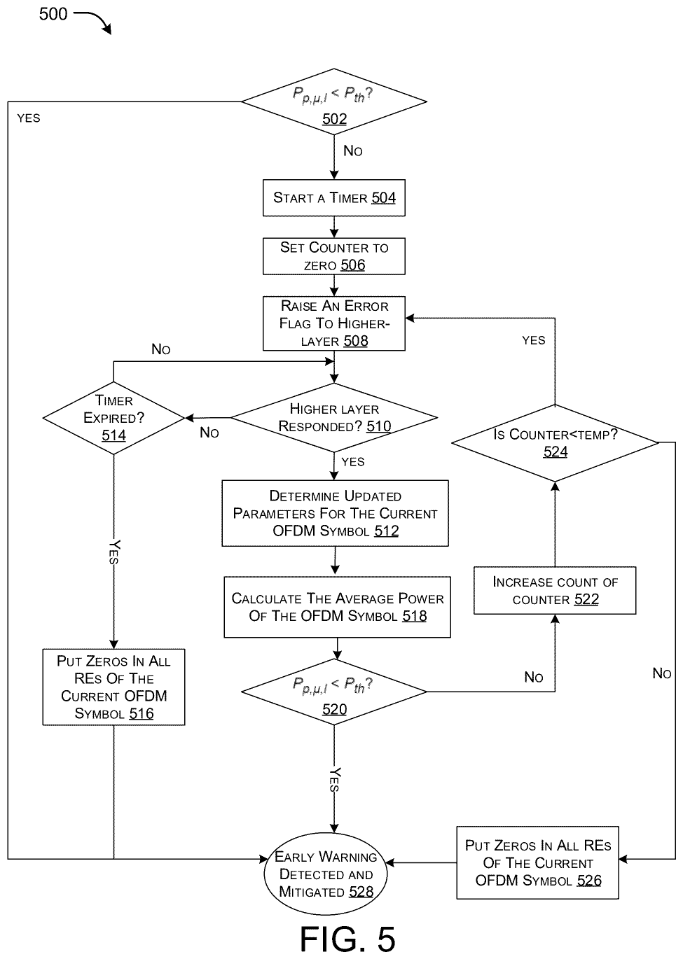

FIG. 5 illustrates a flow chart of an example method (500) of early warning detection (304) and mitigation, in accordance with an embodiment of the present disclosure.

Referring to FIG. 5, at block 502, the method (500) includes reading an average power of each OFDM symbol (P_{p,μ,l}) from the SAP calculator (122) and comparing with a power threshold value Pₜₕ. The value of the power threshold value Pₜₕ may depend upon the DAC resolution, data bits for unity average power, and reserved bits for power scaling factors. For example, consider the DAC (110) with 14-bit resolution in which the first most significant bit (MSB) is used as a sign bit, and the remaining 13 bits are used as data bits. 11 least significant bits (LSBs) are considered data transmission bits with unity power, and the remaining 2 bits are reserved. In an event when the power scaling factors increase the average power of the OFDM symbol, then 11 bits are inadequate to represent in-phase quadrature (IQ) samples. In such a case, the remaining 2 bits can be used along with 11 bits to represent the IQ samples. Each reserved bit can be used to represent the IQ samples with 3 dB additional power. This means 2 reserved bits with 11 bits can represent the IQ samples when the average power is increased by at most 6 dB. If it is more than 6 dB, then there will be data overflow in the DAC (110), which may lead to HPA burnout. In this case, 6 dB is used to define the power threshold value. In some embodiments, when P_{p,μ,l}<Pₜₕ is satisfied, then the OFDM symbol will not change, and the method (500) has detected and mitigated early warning, at 528. In some other embodiments, if P_{p,μ,l}<Pₜₕ is not satisfied, the method (500), at block 504 may include starting or initiating, via the EWD (126), a timer for a predetermined time period. At block 506, the method (500) may include setting a counter to zero. The value of the timer may be configurable and set as per design implementation.

Referring to FIG. 5, at block 508, the method (500) may include transmitting an error flag corresponding to a faulty OFDM symbol to the higher layer (104) via the EWD (126). The EWD (126) reports this violation to the higher layer (104) to reconsider the scaling factor of the faulty OFDM symbol. At block 510, the method (500) may include determining whether the higher layer (104) responds with updated parameters corresponding to the faulty OFDM symbol within the predetermined period. At block 514, the method (500) includes determining whether the timer has expired. If the timer has not expired, i.e., the predetermined time period is not over, then the method (500) may continue to determine whether the higher layer (104) has responded. If the timer expired, the method (500), at block 516, may include configuring zeroes in all REs of the faulty OFDM symbol. If, at block 510, it is determined that the higher layer (104) has responded, the method (500), at block 512, may include determining the updated parameters for the faulty OFDM symbol, and at block 518, may include calculating the average power of OFDM symbol considering the updated parameters.

At block 520, the method (500) may include determining whether the average power is within the power threshold value. If P_{p,μ,l}<Pₜₕ is satisfied, then the new average power of the OFDM symbol may be considered, and the method (500) has detected and mitigated early warning, at 528. If P_{p,μ,l}<Pₜₕ is not satisfied, the method (500), at block 522, may include increasing a count of the counter value by 1, and at block 524, may include comparing the count with a temporary variable (temp). The temp value may be configurable and set as per design implementation. For example, temp can be defined as:

$$temp = ⌊ \frac{Timer Value}{Time taken to execute step 6 to step 10} ⌋$$

where └⋅┘ is floor function.

If counter<temp is satisfied, the method (500) may proceed to block 508 and repeat the steps, as discussed above. If counter<temp is not satisfied, the method (500), at block 526, may include configuring zeros in all REs of the faulty OFDM symbol, and the method (500) has detected and mitigated early warning, at 528.

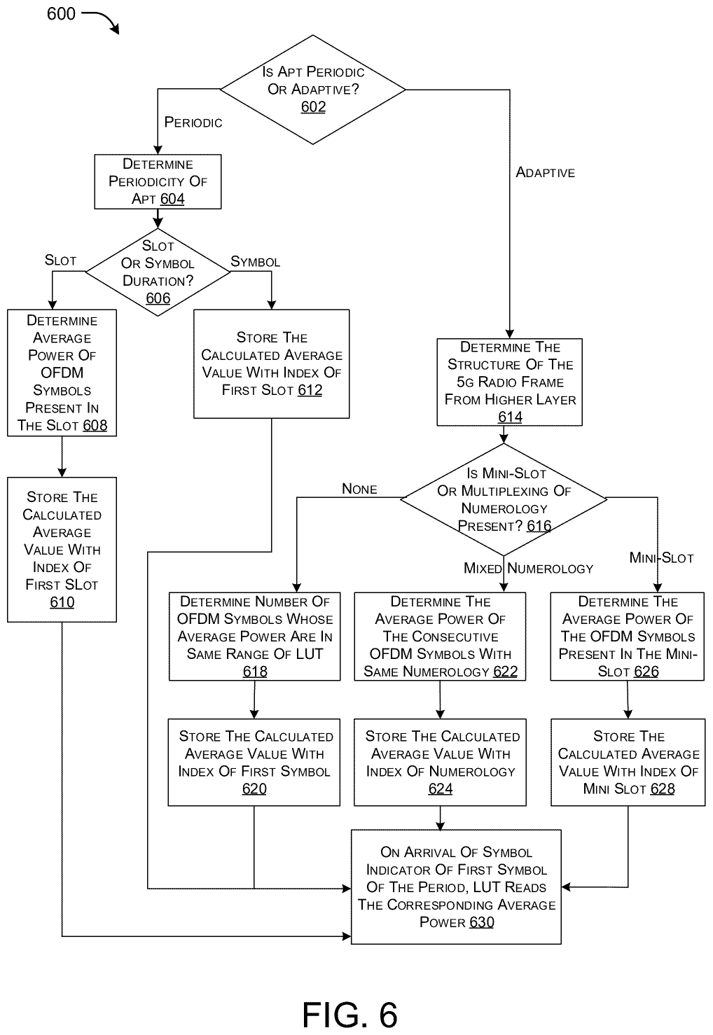

FIG. 6 illustrates a flow chart of an example method (600) for adaptive average power detection (306), in accordance with an embodiment of the present disclosure.

Referring to FIG. 6, at block 602, the method (600) may include determining whether the averaging window is periodic or adaptive, i.e. whether average power tracking (APT) is periodic or adaptive. In other words, the adaptive APD (114-2) determines the number of OFDM symbols required to calculate the average power for APT operation. In case of the averaging window being periodic, the method (600), at block 604, may include determining a periodicity of the averaging window, or APT. The periodicity may be one or more OFDM symbols or one or more slots. He periodicity may be configurable and set as per design implementation. At block 606, the method (600) may include determining whether the periodicity is slot or symbol duration.

If the periodicity corresponds to slots, the method (600), at block 608, may include determining average power of OFDM symbols present in the slot. At block 610, the method (600) may include storing the calculated average value with index of first slot in a local database. If the periodicity corresponds to symbol duration, the method (600), at block 612, may include storing the average power of OFDM symbols present within the averaging window, with index of first symbol in the local database. For example, if APT has an averaging window of 2 OFDM symbols, the adaptive APD (114-2) may read the average symbol power of 2 OFDM symbols from the start of the frame and calculate their average power. The index of the first OFDM symbol and average power may be stored in the local database.

At block 602, if it is determined that the APT is adaptive, it means the averaging window may vary dynamically depending on the structure of the radio frame, the method (600), at block 614, may include determining the structure of the radio frame from the higher layer (104). At block 616, the method (600) may include determining whether mini-slot or multiplexing of numerology is present. If neither of mini-slot nor mixed numerology is present, the method (600), at block 618, may include determining a number of OFDM symbols whose average power is in same range of LUT (116). At block 620, the method (600) may include storing the average value with index of first symbol in the local database. If mixed numerology is present, the method (600), at block 622, may include determining the average power of consecutive OFDM symbols with same numerology. At block 624, the method (600) may include storing the average power with index of numerology in the local database. If mini-slot is present, the method (600), at block 626, may include determining average power of OFDM symbols present in the mini-slot. At block 628, the method (600) may include storing the average power with index of mini-slot.

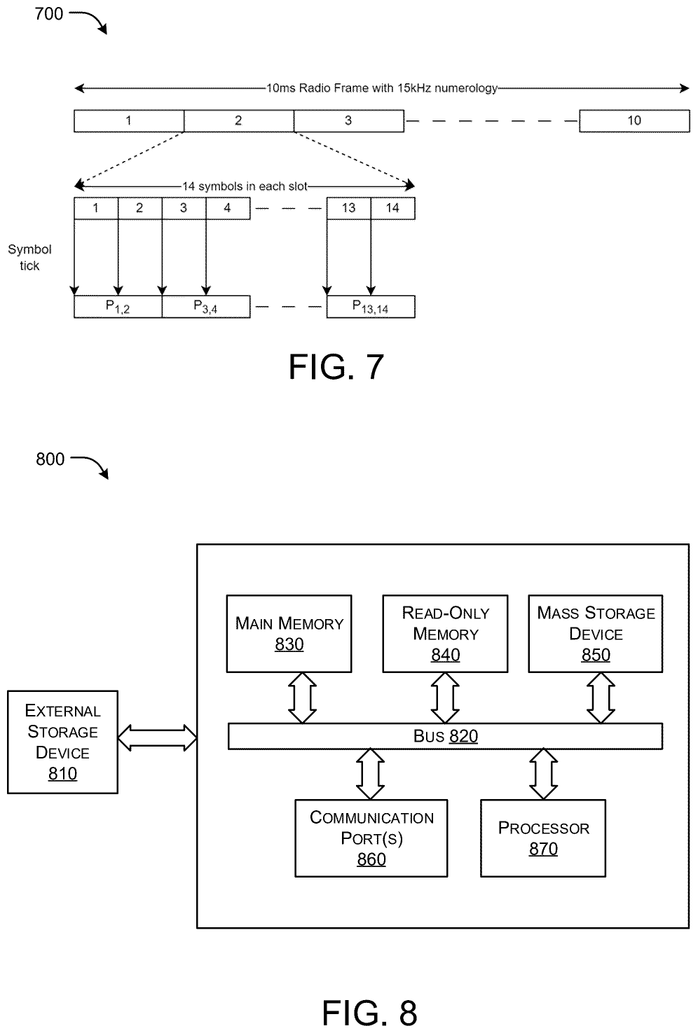

At block 630, on the arrival of a symbol indicator of the first OFDM symbol, the average power may be read by the LUT (116) for further processing, as shown in representation (700) of FIG. 7.

The present disclosure for adaptive average power tracking is applicable to all 5G devices like base station (BS) such as Next-Generation Node B (gNodeB), Evolved Node B (eNodeB), etc., user equipment (UE), customer premises equipment (CPE), etc. This provides an adaptive transmission power control so that the other device in the transmission chain like PA (112) and DAC (110) do not have any adverse impact. It utilizes information available from the higher layer (104) instead of PHY layer (106) so that the hardware resource utilization may be optimized.

FIG. 8 illustrates an example computer system (800) in which or with which embodiments of the present disclosure may be implemented.

The blocks of the flow diagrams shown in FIGS. 3-6 have been arranged in a generally sequential manner for ease of explanation; however, it is to be understood that this arrangement is merely exemplary, and it should be recognized that the processing associated with methods (300, 400, 500, 600) may occur in a different order (for example, where at least some of the processing associated with the blocks is performed in parallel and/or in an event-driven manner). Further, it may be appreciated that the steps shown in FIGS. 3-6 are merely illustrative. Other suitable steps may be used for the same, if desired. Moreover, the steps of the method (300, 400, 500, 600) may be performed in any order and may include additional steps.

The methods and techniques described herein may be implemented in digital electronic circuitry, field programmable gate array (FPGA), or with a programmable processor (for example, a special-purpose processor or a general-purpose processor such as a computer) firmware, software, or in combinations of them. Apparatus embodying these techniques may include appropriate input and output devices, FPGA, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system, explained in detail with reference to FIG. 8, including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), and flash memory devices; magnetic disks such as internal hard disks and removable disks; and magneto-optical disks. Any of the foregoing may be supplemented by, or incorporated in, specially designed application-specific integrated circuits (ASICs).

In particular, FIG. 8 illustrates an exemplary computer system (800) in which or with which embodiments of the present disclosure may be utilized. The computer system (800) may be implemented as or within the system (200) described in accordance with embodiments of the present disclosure.

As depicted in FIG. 8, the computer system (800) may include an external storage device (810), a bus (820), a main memory (830), a read-only memory (840), a mass storage device (850), communication port(s) (860), and a processor (870). A person skilled in the art will appreciate that the computer system (800) may include more than one processor (870) and communication ports (860). The processor (870) may include various modules associated with embodiments of the present disclosure. The communication port(s) (860) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (860) may be chosen depending on a network, such a Local Area Network (LAN), Wide Area Network (WAN), or any network to which the computer system (800) connects.

In an embodiment, the main memory (830) may be Random Access Memory (RAM), or any other dynamic storage device commonly known in the art. The read-only memory (840) may be any static storage device(s) e.g., but not limited to, a Programmable Read Only Memory (PROM) chips for storing static information e.g., start-up or basic input output system (BIOS) instructions for the processor (870). The mass storage device (850) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (820) communicatively couples the processor (870) with the other memory, storage, and communication blocks. The bus (820) may be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (870) to the computer system (800).

In another embodiment, operator and administrative interfaces, e.g., a display, keyboard, and a cursor control device, may also be coupled to the bus (820) to support direct operator interaction with the computer system (800). Other operator and administrative interfaces may be provided through network connections connected through the communication port(s) (860). Components described above are meant only to exemplify various possibilities. In no way should the aforementioned exemplary computer system (800) limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a system and a method thereof for adaptive average power tracking in a wireless communication system.

The present disclosure facilitates to prevent high-power amplifier and other components in the wireless communication system from damage.

The present disclosure facilitates to utilize information from a higher layer to optimize hardware resource utilization.

I/We claim:

1. A method (300) for adaptive average power tracking in a wireless communication system (200), comprising:
determining, by a processor (870), an average power of each of a plurality of Orthogonal Frequency-Division Multiplexing (OFDM) symbols in a radio frame based on a set of power scaling factors and a number of Resource Elements (REs) associated with each OFDM symbol;
comparing, by the processor (870), the average power of each of the plurality of OFDM symbols with a power threshold value;
detecting, by the processor (870), one or more faulty OFDM symbols among the plurality of OFDM symbols based on the comparison;
modifying, by the processor (870), the one or more faulty OFDM symbols;
determining, by the processor (870), an average power of a set of OFDM symbols, including the one or more modified OFDM symbols, corresponding to an averaging window; and
generating, by the processor (870), a modulated voltage supply for a power amplifier (112) in the wireless communication system (200) based on the determined average power of the set of OFDM symbols.

2. The method (300) as claimed in claim 1, wherein determining, by the processor (870), the average power of each of the plurality of OFDM symbols comprises:
receiving, by the processor (870), the set of power scaling factors of physical channels and reference signals from a higher layer (104) in the wireless communication system (200);
determining, by the processor (870), power scaling factors of multiple-input multiple-output (MIMO) precoding weights and/or beamforming weights for each transmit chain associated with the wireless communication system (200); and
determining, by the processor (870), the number of REs associated with the physical channels and the reference signals mapped to each OFDM symbol.

3. The method (300) as claimed in claim 2, wherein the average power of each of the plurality of OFDM symbols is determined based on at least one of: the set of power scaling factors of the physical channels and the reference signals, the power scaling factors of the MIMO precoding weights and/or the beamforming weights, and the number of REs associated with the physical channels and the reference signals.

4. The method (300) as claimed in claim 1, wherein detecting, by the processor (870), the one or more faulty OFDM symbols comprises:
for each of the plurality of OFDM symbols:
determining, by the processor (870), whether the average power of a given OFDM symbol is less than the power threshold value;
in response to a determination that the average power of the given OFDM symbol is less than the power threshold value, identifying, by the processor (870), that the given OFDM symbol is not faulty; and
in response to a determination that the average power of the given OFDM symbol is greater than the power threshold value, identifying, by the processor (870), that the given OFDM symbol is a faulty OFDM symbol.

5. The method (300) as claimed in claim 4, wherein modifying, by the processor (870), the one or more faulty OFDM symbols comprises:
for each of the one or more faulty OFDM symbols:
initiating, by the processor (870), a timer for a predetermined time period, and a counter to zero;
transmitting, by the processor (870), an error flag corresponding to a given faulty OFDM symbol to a higher layer (104) in the wireless communication system (200); and
determining, by the processor (870), whether the higher layer (104) responds with updated parameters corresponding to the given faulty OFDM symbol within the predetermined time period.

6. The method (300) as claimed in claim 5, comprising:
in response to a determination that the higher layer (104) does not respond within the predetermined time period, configuring, by the processor (870), zeroes in REs of the given faulty OFDM symbol; or
in response to a determination that the higher layer (104) responds within the predetermined time period:
determining, by the processor (870), an updated average power of the given faulty OFDM symbol, based on the updated parameters received from the higher layer (104);
determining, by the processor (870), whether the updated average power is less than the power threshold value; and
in response to a determination that the updated average power is greater than the power threshold value, increasing, by the processor (870), a count of the counter and determining, by the processor, whether the count is less than a counter threshold value.

7. The method (300) as claimed in claim 6, comprising:
in response to a determination that the count is less than the counter threshold value, re-transmitting, by the processor (870), the error flag to the higher layer (104); or
in response to a determination that the count is greater than the counter threshold value, configuring, by the processor (870), the zeroes in the REs of the given faulty OFDM symbol.

8. The method (300) as claimed in claim 1, comprising determining, by the processor (870), whether the averaging window is periodic or adaptive.

9. The method (300) as claimed in claim 8, wherein in case of the averaging window being periodic, the method (300) comprises:
determining, by the processor (870), a periodicity of the averaging window; and
storing, by the processor (870), the average power of the set of OFDM symbols corresponding to the averaging window and an index of a start of the averaging window in a database.

10. The method (300) as claimed in claim 8, wherein in case of the averaging window being adaptive, the method (300) comprises:
determining, by the processor (870), a structure of the radio frame; and
storing, by the processor (870), the average power of the set of OFDM symbols corresponding to the averaging window and an index of a first OFDM symbol corresponding to one of: the set of OFDM symbols within a mini-slot, the set of OFDM symbols having same numerology, or the set of OFDM symbols where the average power of a number of consecutive OFDM symbols lies in same range of a Look-Up Table (LUT).

11. The method (300) as claimed in claim 1, wherein generating, by the processor (870), the modulated power supply comprises:
receiving, by the processor (870), a symbol indicator of a first OFDM symbol of the set of OFDM symbols from a timing module (122) in the wireless communication system (200);
converting, by the processor (870), the average power of the set of OFDM symbols into a codeword using a Look-Up Table (LUT) at the symbol indicator of the first OFDM symbol; and
generating, by the processor (870), the modulated power supply based on the codeword,
wherein the modulated power supply is delayed to align with an input signal at the power amplifier (112).

12. A system (200) for adaptive average power tracking, comprising:
a processor (870); and
a memory (840) operatively coupled with the processor (870), wherein the memory (840) comprises processor-executable instructions which, when executed by the processor (870), cause the processor (870) to:
determine an average power of each of a plurality of Orthogonal Frequency-Division Multiplexing (OFDM) symbols in a radio frame based on a set of power scaling factors and a number of Resource Elements (REs) associated with each OFDM symbol;
compare the average power of each of the plurality of OFDM symbols with a power threshold value;
detect one or more faulty OFDM symbols among the plurality of OFDM symbols based on the comparison;
modify the one or more faulty OFDM symbols;
determine an average power of a set of OFDM symbols, including the one or more modified OFDM symbols, corresponding to an averaging window; and
generate a modulated voltage supply for a power amplifier (112) in the system (200) based on the determined average power of the set of OFDM symbols.
